(19) United States
(12) Patent Application Publication
(10) Pub. No.: US 2026/0284679 A1
(43) Pub. Date: Sep. 24, 2026

(54) BLOW GUN

(71) Applicant: CEJN AB, Skövde (SE)

(72) Inventor: Joachim Schöter, Skövde (SE)

(21) Appl. No.: 19/480,307

(22) PCT Filed: Apr. 26, 2024
(86) PCT No.: PCT/EP2024/061508

§ 371 Date: Oct. 30, 2025

(30) Foreign Application Priority Data
May 3, 2023 (SE) 2350537.3

(51) Int. Cl. B05B 1/00; B05B 1/30; B05B 12/00

(52) U.S. Cl. CPC B05B 1/005; B05B 1/3026; B05B 12/002

(57) ABSTRACT

A blow gun comprising at least the following components is disclosed: a body; a handle; a nozzle; and a valve. Each component is detectable by an x-ray detector and a metal detector, and the handle acts directly on the valve. Any part of each component may be detectable by the x-ray detector and the metal detector. An assembly of the blow gun, a quick connect coupling, a hose, and a hose reel is disclosed. Each component of the coupling, the hose, and the hose reel may be detectable by an x-ray detector and a metal detector. By making each and every component and part of each component detectable by both an x-ray detector and a metal detector, the blow gun and any part thereof can be detected and therefore used in the food and beverage and medical industries.

### TECHNICAL FIELD

The present disclosure relates to a blow gun. More particularly, the present disclosure relates to a blow gun that can be used in the food and beverage and medical industries. The blow gun blows, for example, compressed air.

### BACKGROUND

It is desirable for the food and beverage industry to use blow guns. However, this is often not possible because the food and beverage and medical industries must ensure that there are no foreign objects in the food or beverage or medicine that is produced. Foreign objects in the food products may, for example, cause bad reputation, negative publicity, and personal injury.

It is a problem how to provide a blow gun for the food and beverage industry. It is desirable that a blow gun is made out of plastic since there are many advantages with plastic, such as for example low production costs, easy to clean, no corrosive properties, weight, and last long. The blow gun must also be able to withstand aggressive detergents used to clean in the food and beverage and medical industries.

One problem is to produce such a blow gun for the food and beverage and medical industries with good quality. It should be inexpensive to manufacture such a blow gun. The blow gun should also be able to provide a good and reliable operation of the blow gun. The blow gun must also be compatible with existing accessories for existing blow guns. The present disclosure is directed to overcoming one or more of the problems set forth above.

### SUMMARY

Embodiments of the present disclosure provide a blow gun for the food, beverage, and medical industries, an assembly comprising such a blow gun, and the use of such a blow gun in the food, beverage, and medical industries.

According to one embodiment, a blow gun comprising at least the following components is disclosed: a body; a handle; a nozzle; and a valve. Each component is detectable by an x-ray detector and a metal detector. The handle acts directly on the valve. The blow gun is detectable by both the x-ray detector and the metal detector, because each component is configured such that it is detectable by the x-ray detector and the metal detector. Any part of each component may be detectable by the x-ray detector and the metal detector. Detectable by an x-ray detector and a metal detector may correspond to the same level of detectability as an x-ray detector and a metal detector detecting a stainless steel ball with a diameter of 2 millimetres. Any part of each component may, for example, be at least 2×2×2 mm, for example, 8 cubic millimetres.

According to one embodiment, the blow gun may further comprise any combination of one or more of the following further components: a tube, a regulator, a seal, a coupling, a cap, a bushing, a lip seal, a spring, and a hook; wherein each further component is detectable by the x-ray detector and the metal detector. Any part of each further component may be detectable by the x-ray detector and the metal detector.

According to one embodiment, the body and the handle may comprise a thermoplastic with one or more additives, the additives being detectable by the x-ray detector and the metal detector. The thermoplastic may comprise one or more of the following group: a thermoplastic polymer, polyamide PA66, polyamide PA6, and Polyoximetylen. The additives may comprise iron oxide. Each seal may comprise one or more additives, the additives being detectable by the x-ray detector and the metal detector. The seal may be an o-ring or a lip seal. The nozzle and/or the tube may be made out of brass or stainless steel.

According to one embodiment, the valve may be made out of a thermoplastic with one or more additives as mentioned herein, the additives being detectable by the x-ray detector and the metal detector. The valve may be made out of metal, for example, brass or stainless steel.

According to one embodiment, an assembly of the blow gun according to any embodiment described herein is disclosed. The assembly may comprise the blow gun and a quick connect coupling and a hose. Both the quick connect coupling and the hose may comprise further components, wherein each further component may be detectable by an x-ray detector and a metal detector. The assembly may further comprise a hose reel, wherein each component of the hose reel may be detectable by an x-ray detector and a metal detector. All components of the assembly, and all parts of the components, may be configured such that they are detectable by an x-ray detector and a metal detector.

At least one embodiment disclosed herein provides a blow gun that can be used in the food and beverage and medical industries. Any part of the blow gun is detectable in the x-ray detector and the metal detector. By making each and every component detectable by both an x-ray detector and a metal detector, the blow gun and any part thereof can be detected and therefore used in the food and beverage and medical industries.

One or more embodiments disclosed herein provide a blow gun that can be accepted and used by the food and beverage and medical industries. At least one embodiment provides a blow gun that provides one or more solutions to the problems and disadvantages described herein. Other technical advantages of the present disclosure will be readily apparent to one skilled in the art from the following description and claims. Various embodiments of the present application obtain only a subset of the advantages set forth. No one advantage is critical to the embodiments. Any embodiment disclosed herein may be technically combined with any other embodiment, or embodiments, disclosed herein.

### BRIEF DESCRIPTION OF THE DRAWINGS

The accompanying drawings illustrate presently example embodiments of the disclosure, and together with this disclosure serve to explain, by way of example, the principles of the disclosure.

FIG. 1 is a diagrammatic illustration of a blow gun according to an example embodiment of the present disclosure.

### DETAILED DESCRIPTION

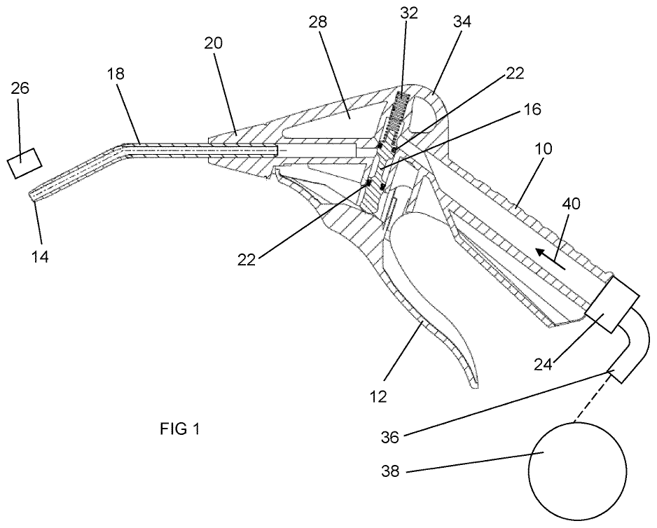

FIG. 1 is a diagrammatic illustration of an example embodiment of a blow gun. The blow gun is shown in a view that is a cut through the blow gun, i.e., a vertical cut when a user holds the blow gun in a normal way to operate the blow gun by hand. The blow gun in FIG. 1 comprises at least the following components: a body 10; a handle 12; a nozzle 14; and a valve 16. The blow gun may comprise more components that make up the blow gun. Each component is detectable by an x-ray detector and a metal detector. Each component is configured such that it is detectable by an x-ray detector and a metal detector. Any part of each component may be detectable by the x-ray detector and the metal detector. All components, or all parts of each component, may be configured such that they are detectable by both an x-ray detector and a metal detector.

The body 10 may support the handle 12 for rotation at one end of the handle 12. The handle 12 may be shaped for a user's hand on the opposite end of the handle 12. In between the ends of the handle 12 may be configured to open and/or close the valve 16 in the body 10. The handle 12 may have a protrusion that interacts with the body 10 to restrict the pivot motion of the handle 12 with respect to the body 10. This ensures that the handle 12 has an end position where the valve 16 is closed.

Detectable by an x-ray detector and a metal detector may correspond to the same level of detectability as an x-ray detector and a metal detector detecting a stainless steel ball with a diameter of 2 millimetres. Any part of each component may, for example, be at least 2×2×2 mm, for example, 8 cubic millimetres.

Any part of the blow gun may be detectable by an x-ray detector and a metal detector of the food and beverage and medical industries. This may allow the blow gun to solve the problems mentioned above. Any component, or part of a component, may be used in the food and beverage industry since it may be detected by both an x-ray detector and a metal detector.

With reference to FIG. 1, the blow gun may further comprise any combination of one or more of the following further components: a tube 18, a regulator 20, a seal 22, a coupling 24, a cap 26, a spring 32, and a hook 34. Each further component may be detectable by the x-ray detector and the metal detector. Any part of each further component may detectable by the x-ray detector and the metal detector. By making each and every component, and each part of each component, detectable by both an x-ray detector and a metal detector, the blow gun solves the problem mentioned herein. The seal 22 may, for example, be an O-ring, a lip seal, or an X-ring. The tube 18 may, for example, be a bushing, or a pipe. The coupling 24 may be a quick connect coupling or nipple.

With reference to FIG. 1, the body 10 and the handle 12 of the blow gun may comprise a thermoplastic with one or more additives, the additives being detectable by the x-ray detector and the metal detector. The body 10 and the handle 12 may be made entirely out of the thermoplastic with one or more additives. The thermoplastic may comprise any one of a thermoplastic polymer, polyamide PA66, polyamide PA6, and Polyoximetylen, or any combination thereof. Polyamide PA66 is also known as nylon 66. The additive may be one or more of the chemical compounds belonging to the group of iron oxides, for example, any chemical compounds composed of iron and oxygen. Any additive mentioned herein may, for example, be iron oxide. By mixing the additive into the thermoplastic even a very small part, for example 2×2×2 mm, for example 8 cubic millimetres, may be detectable by an x-ray detector and a metal detector. The additive not only improves the detectability for the metal detector, but also for the x-ray detector. By using a thermoplastic with one or more additives the blow gun may still withstand aggressive detergents used to clean in the food and beverage industry. Such a blow gun would also have low production costs, would be easy to clean, would have no corrosive properties, have a low weight, and have a long life span.

Each seal 22 in the blow gun may comprise one or more additives, the additives being detectable by the x-ray detector and the metal detector. The additives may be any additives mentioned herein. The seal 22 may be an o-ring or a lip seal, or any seal comprising a thermoplastic with one or more additives.

The nozzle 14 and/or the tube 18 may be made out of brass or stainless steel. The nozzle 14 and the tube 18 may be separate components or may be integral components. The nozzle 14 may have a cap 26 that can be mounted onto the nozzle 14. The cap 26 may comprise one or more additives, the additives being detectable by the x-ray detector and the metal detector. The additives may be any additives mentioned herein. The cap 26 may be attached, for example, by a wire, to the body 10.

The valve 16 may be made out of a thermoplastic with one or more additives, the additives being detectable by the x-ray detector and the metal detector. The valve 16 may be made out of metal, brass, or stainless steel. The valve 16 may have at least two seals 22 around it. The valve 16 and the spring 32 may be connected to each other in the axial direction of the valve 16 and the spring 32. The spring 32 may be metal, for example, stainless steel. The handle 12 may be rotatably fastened, hinged, to the body 10, and the spring 32 may force the handle 12 rotatably away from the body 10. As illustrated in FIG. 1, pressing the handle 12 towards the body 10 may gradually open the valve 16 to allow fluid to flow through the blow gun in the flow direction 40.

The body 10 may comprise a through hole 28 as illustrated in FIG. 1. The through hole 28 is convenient for gripping or hanging up the blow gun. The body 10 may also comprise a hook 34. The hook 34 may be used for hanging up the blow gun, but may also be provided to protect a protrusion of the body 10 comprising the spring 32. The hook 34 may be shaped as a loop. As illustrated in FIG. 1, the through hole 28 may be on one side of the protrusion, and the hook 34 may be on the opposite side. This protects the blow gun against impact and contributes to ensuring that no part of the blow gun is lost in the production process in the food, beverage, or medical industries.

As illustrated in FIG. 1, the handle 12 acts directly on the valve 16. With no parts between the moving handle 12 and the moving valve 16, the blow gun disclosed herein provides the advantage of having no small parts that can be lost in the food, beverage, or medical industries.

According to one embodiment, that may be combined with any embodiments disclosed herein, an assembly of the blow gun, according to any one of the embodiments disclosed herein, together with a quick connect coupling 24 and a hose 36 is disclosed. Both the quick connect coupling 24 and the hose 36 may comprise further components and each component is detectable by an x-ray detector and a metal detector. All components of the assembly, and all parts of the components, may be configured such that they are detectable by an x-ray detector and a metal detector, as described herein. FIG. 1 illustrates the quick connect coupling 24 coupled to the blow gun and the hose 36 supplying the blow gun with fluid, for example, compressed air.

As illustrated in FIG. 1, the assembly may further comprise a hose reel 38. This allows the hose 36 to be reeled and unreeled. Each component of the hose reel 38 may be detectable by an x-ray detector and a metal detector. In the same way as described above, using the same thermoplastic with one or more additives, where the additives being detectable by the x-ray detector and the metal detector, the entire assembly of the blow gun, the quick connect coupling 24, the hose 36, and the hose reel 38 may be used in the food, beverage, and/or medical industries. In FIG. 1, the quick connect coupling 24 has been illustrated schematically, as well as the initial part of the hose 36 from the quick connect coupling 24. A section of the hose 36 to the hose reel 38 has been illustrated schematically with a dashed line.

According to one embodiment that may be combined with any embodiments disclosed herein, an assembly of the blow gun, according to any one of the embodiments disclosed herein, together with an x-ray detector and/or a metal detector is disclosed. By providing an x-ray detector and/or a metal detector for the products produced by a facility making food, beverage, and/or medical products, the blow gun can be used at the facility, since each and every component, and each part of each component, of the blow gun is detectable by both the x-ray detector and the metal detector. The x-ray detector and the metal detector may be configured to detect at least a stainless steel ball with a diameter of 2 millimetres. Any part of each component may, for example, be at least 2×2×2 mm, for example, 8 cubic millimetres.

At least one embodiment disclosed herein provides a blow gun that can be used in the food and beverage and medical industries. Any part of the blow gun is detectable in the x-ray detector and the metal detector. By making each and every component detectable by both an x-ray detector and a metal detector, the blow gun and any part thereof can be detected and therefore used in the food and beverage and medical industry.

It will be apparent to those skilled in the art that various modifications and variations can be made to the blow gun. Other embodiments will be apparent to those skilled in the art from consideration of the specification and practice of the disclosed blow gun. It is intended that the specification and embodiments be considered as examples only, with a true scope being indicated by the following claims and their equivalents.

### LIST OF ELEMENTS

10 body
12 handle
14 nozzle
16 valve
18 tube
20 regulator
22 seal
24 coupling
26 cap
28 through hole
32 spring
34 hook
36 hose
38 hose reel
40 flow direction

1. A blow gun comprising:
a body;
a handle;
a nozzle; and
a valve coupled to the handle;
wherein the body, the handle, the nozzle, and the valve are detectable by an x-ray detector and a metal detector.

2. The blow gun according to claim 1, wherein any part of the body, the handle, the nozzle, or the valve is detectable by the x-ray detector and the metal detector.

3. The blow gun according to claim 1, further comprising at least one of:
a tube, a regulator, a seal, a coupling, a cap, a spring, or a hook; and
wherein the at least one of the tube, the regulator, the seal, the coupling, the cap, the spring, or the hook is detectable by the x-ray detector and the metal detector.

4. The blow gun according to claim 1, wherein the body and the handle comprise a thermoplastic with one or more additives, the additives being detectable by the x-ray detector and the metal detector.

5. The blow gun according to claim 4, wherein the thermoplastic comprises one or more of the following group: a thermoplastic polymer, polyamide PA66, polyamide PA6, and Polyoximetylen.

6. The blow gun according to claim 4, wherein the additives comprise iron oxide.

7. The blow gun according to claim 3, wherein each seal comprises one or more additives, the additives being detectable by the x-ray detector and the metal detector.

8. The blow gun according to claim 3, wherein at least one of the nozzle or the tube is made out of brass or stainless steel.

9. The blow gun according to claim 1, wherein the valve is made out of a thermoplastic with one or more additives, the additives being detectable by the x-ray detector and the metal detector.

10. The blow gun according to claim 1, wherein the valve is made out of metal.

11. The blow gun according to claim 1, wherein the body comprises a through hole.

12. The blow gun according to claim 1, further comprising a quick connect coupling and a hose, both comprising components, wherein each component is detectable by an x-ray detector and a metal detector.

13. The blow gun according to claim 12, further comprising a hose reel, wherein each component of the hose reel is detectable by an x-ray detector and a metal detector.

14. The blow gun according to claim 1, wherein the blow gun is utilized in one or more of the following: the food industry, the beverage industry, and the medical industries.
